(19) United States
(12) Patent Application Publication
(10) Pub. No.: US 2026/0300829 A1
(43) Pub. Date: Oct. 1, 2026

(54) METHODS AND SYSTEMS FOR SYNTHESIZING FREQUENCY DOMAIN DATA FOR A TARGET STATE

(71) Applicant: TDK U.S.A. Corporation, Uniondale, NY (US)

(72) Inventors: Vishal VIJAYAKUMAR, Fremont, CA (US); Juan S Mejia SANTAMARIA, San Jose, CA (US); Abbas ATAYA, Menlo Park, CA (US); Vishal Reddy GADE, San Jose, CA (US)

(73) Assignee: TDK U.S.A. Corporation, Uniondale, NY (US)

(21) Appl. No.: 19/578,223

(22) Filed: Mar. 25, 2026

Related U.S. Application Data
(60) Provisional application No. 63/780,102, filed on Mar. 28, 2025.

(51) Int. Cl. G06N 20/00

(52) U.S. Cl. CPC G06N 20/00

(57) ABSTRACT

In a method for synthesizing frequency domain data for a target state, the method comprising, frequency domain data for an input state and a target state for a subject is received, wherein the frequency domain data exhibits morphologically dominant periodicity. A warping map between local regions of the frequency domain data for the input state and the target state is generated. Synthetic frequency domain data at the target state is generated based at least in part on applying the frequency domain data for the input state to the warping map.

### RELATED APPLICATION

This application claims priority to and the benefit of co-pending U.S. Provisional Patent Application 63/780,102, filed on Mar. 28, 2025, entitled “A FRAMEWORK AND METHOD TO SYNTHESIZE FREQUENCY SPECTRA FOR CONDITION-BASED MONITORING APPLICATIONS,” by Vijayakumar et al., having Attorney Docket No. IVS-1162-PR, and assigned to the assignee of the present application, which is incorporated herein by reference in its entirety.

### BACKGROUND

In many industries, equipment and machinery are critical to operations, and unexpected failures can lead to significant downtime, costly repairs, and safety hazards. Traditional maintenance approaches, such as scheduled maintenance, often fail to predict and prevent these failures because they do not account for the actual condition of the equipment. Fault diagnosis and prognosis typically rely on data collected from monitored equipment and machinery. However, acquiring such data is challenging due to the cost, complexity, and controlled conditions required to replicate specific faults in a physical system.

### BRIEF DESCRIPTION OF DRAWINGS

The accompanying drawings, which are incorporated in and form a part of the Description of Embodiments, illustrate various non-limiting and non-exhaustive embodiments of the subject matter and, together with the Description of Embodiments, serve to explain principles of the subject matter discussed below. Unless specifically noted, the drawings referred to in this Brief Description of Drawings should be understood as not being drawn to scale and like reference numerals refer to like parts throughout the various figures unless otherwise specified.

FIG. 1 is a block diagram illustrating an example system for generating synthetic frequency domain data for a target state, in accordance with embodiments.

FIG. 2 is a block diagram of an example warping map generator, in accordance with embodiments.

FIGS. 3A and 3B are graphs illustrating example warping maps between two states, in accordance with embodiments.

FIG. 4 is a block diagram illustrating an example data synthesis system for synthesizing target data by accessing a warping map database, in accordance with embodiments.

FIG. 5 is a block diagram illustrating an example data synthesis system for synthesizing target data by generating a warping map, in accordance with embodiments.

FIG. 6 is a block diagram illustrating an example data synthesis system for synthesizing target data using multiple query inputs and blending the candidate synthesized target data in blended target data, in accordance with embodiments.

FIG. 7A are graphs illustrating example warping map generation, in accordance with embodiments.

FIG. 7B are graphs illustrating an example blending operation, in accordance with embodiments.

FIG. 8 is a block diagram illustrating an example data synthesis system for generating data for a second subject based on warping maps for a first subject, in accordance with embodiments.

FIG. 9 is a block diagram illustrating an example machine learning model training system, in accordance with embodiments.

FIG. 10 is a block diagram illustrating an example fault detection module, in accordance with embodiments.

FIG. 11 is a flow diagram illustrating an example method for generating synthetic frequency domain data, according to embodiments.

FIG. 12 is a flow diagram illustrating another example method for generating synthetic frequency domain data, according to embodiments.

FIG. 13 is a flow diagram illustrating an example method for blending synthetic data, according to embodiments.

FIG. 14 is a flow diagram illustrating an example method for using a warping map generated for a first subject to generate synthetic frequency domain data for a second subject, according to embodiments.

FIG. 15 is a flow diagram 1500 illustrating an example method for performing condition-based monitoring at the subject operating at the target state, according to embodiments.

### DESCRIPTION OF EMBODIMENTS

The following Description of Embodiments is merely provided by way of example and not of limitation. Furthermore, there is no intention to be bound by any expressed or implied theory presented in the preceding background or in the following Description of Embodiments.

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Some portions of the detailed descriptions which follow are presented in terms of procedures, logic blocks, processing and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities take the form of acoustic (e.g., ultrasonic) signals capable of being transmitted and received by an electronic device and/or electrical or magnetic signals capable of being stored, transferred, combined, compared, and otherwise manipulated in an electrical device.

It should be borne in mind, however, that all of these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “receiving,” “collecting,” “synthesizing,” “applying,” “training,” determining,” “combining,” “blending,” “training,” “deploying,” “generating,” “deriving,” “analyzing,” “monitoring,” “processing,” “using,” “performing,” “outputting,” “averaging,” “defining,” “sampling,” “transforming,” “computing,” “executing,” “capturing,” “sensing,” “storing,” or the like, refer to the actions and processes of an electronic device.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example ultrasonic sensing system and/or mobile electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration.

### Overview of Discussion

Discussion begins with a description of an example system for generating synthetic frequency domain data for a target state. An example warping map generator is then described. Example data synthesis systems are then described. An example machine learning model training system is then described. An example fault detection system for performing fault detection based on the synthesized fault data is then described. Example operations of generating synthetic frequency domain data for a target state are then described.

Mechanical equipment and machinery are critical components in numerous industrial applications, including aerospace, automotive, and energy production. Ensuring their reliability and performance is crucial, as faults in these systems can lead to catastrophic failures and costly downtime. Sensor data can be used to train condition-based monitoring (CBM) or predictive-based monitoring systems for detecting or predicting machine decline or faults before they occur. In order to train such systems, it is typically useful to have plentiful data from a machine during operation. For time-series data, data collection is a typical pipeline bottleneck for training of such systems.

Embodiments described herein generate synthetic frequency domain data that augments a data set of diverse operating conditions. This synthetic frequency domain data can then be used to train a condition-based monitoring (CBM) algorithm or a predictive-based monitoring algorithm in order to detect or predict machine failures in advance of such a failure, e.g., implemented within a machine learning model. Enabling this proactive approach helps in minimizing unplanned downtime, reducing maintenance costs, and enhancing overall operational efficiency.

The described embodiments address the specific technical problem of lacking a sufficient amount of data across multiple operating conditions necessary for effective CBM and predictive maintenance. Data collection is typically prohibitively time-consuming, leading to a lack of sufficient data hinders the development of accurate predictive models. Embodiments described herein address this need by generating synthetic frequency domain data at a target state using data from an input state and a limited amount data from the target state. This synthetic data fills the gap, enabling the creation of more precise and reliable algorithms for monitoring and predicting equipment failures, ultimately improving maintenance strategies and operational efficiency.

Embodiments described herein provide a method for synthesizing frequency domain data for a target state. Frequency domain data for an input state and a target state for a subject is received, wherein the frequency domain data exhibits morphologically dominant periodicity. In some embodiments, time domain data is first received for the input state and the target state. The time domain data for the input state and the target state is transformed into the frequency domain data for the input state and the target state. In some embodiments, the subject is a machine and wherein the input state and the target state are different operating speeds of the machine. In some embodiments, a change from the input state to the target state at the subject is sensed. Responsive to the sensing the change, frequency domain data for the target state for the subject is automatically collected.

A warping map between local regions of the frequency domain data for the input state and the target state is generated. In some embodiments, the warping map is stored at a map database, wherein the map database comprises a plurality of warping maps for different input states and target states.

Synthetic frequency domain data at the target state is generated based at least in part on applying the frequency domain data for the input state to the warping map. In some embodiments, a scaling factor is applied to the synthetic frequency domain data, wherein the scaling factor is a ratio of amplitudes of the frequency domain data between the input state and the target state. In some embodiments, the synthetic frequency domain data at the target state is transformed into synthetic time domain data at the target state.

In some embodiment, frequency domain data for a second input state is received. A second warping map between local regions of the frequency domain data for the second input state and the target state is generated. Second synthetic frequency domain data is generated at the target state based at least in part on applying the frequency domain data for the second input state to the second warping map. In some embodiments, the synthetic frequency domain data and the second synthetic frequency at the target state are blended to generate blended synthetic frequency domain data.

In some embodiments, the blending the synthetic frequency domain data and the second synthetic frequency at the target state to generate the blended synthetic frequency domain data includes averaging the synthetic frequency domain data and the second synthetic frequency domain data at the target state to generate the blended synthetic frequency domain data. In some embodiments, the blending the synthetic frequency domain data and the second synthetic frequency at the target state to generate the blended synthetic frequency domain data includes determining weights for the synthetic frequency domain data and the second synthetic frequency domain data at the target state based at least in part on a relative distance from the target state. The weights are applied to the synthetic frequency domain data and the second synthetic frequency domain data to generate the blended synthetic frequency domain data. In some embodiments, the blending the synthetic frequency domain data and the second synthetic frequency at the target state to generate the blended synthetic frequency domain data includes using statistical modeling to estimate weights for the synthetic frequency domain data and the second synthetic frequency domain data at the target state. The weights are applied to the synthetic frequency domain data and the second synthetic frequency domain data to generate the blended synthetic frequency domain data.

In some embodiments, frequency domain data for an input state of a second subject is received. A cross-subject warping map between local regions of the frequency domain data for the input state of the subject to the frequency domain data for the input state of the second subject is generated. In some embodiments, synthetic frequency domain data at a target state of the second subject is generated based at least in part on applying the frequency domain data for the input state of the second subject to the cross-subject warping map.

In some embodiments, a machine learning model is trained using the synthetic frequency domain data at the target state to perform condition-based monitoring at the subject operating at the target state. In some embodiments, the machine learning model is a CBM machine learning model for predictive maintenance of the system by enabling fault detection and failure forecasting. In some embodiments, the machine learning model is deployed to perform condition-based monitoring at the subject operating at the target state.

The embodiments described herein greatly extend beyond conventional methods of synthesizing data. The described embodiments provide methods for synthesizing frequency domain data representing at least one operating state of a subject utilizing available sensor data of different operating states, thereby eliminating the need for costly and time-intensive data acquisition for the subjects. The described embodiments also use the synthesized frequency domain data representing different operating states to perform CBM or predictive-based monitoring to detect or predict machine faults before they occur, thereby improving performance of the machines themselves.

### Example Systems for Synthesizing Frequency Domain Data for a Target State

Example embodiments described herein provide methods and systems for generating synthetic frequency domain data for a target state and performing fault detection. Frequency domain data for an input state and a target state for a subject is received, wherein the frequency domain data exhibits morphologically dominant periodicity. A warping map between local regions of the frequency domain data for the input state and the target state is accessed or generated. Synthetic frequency domain data at the target state is generated based at least in part on applying the frequency domain data for the input state to the warping map.

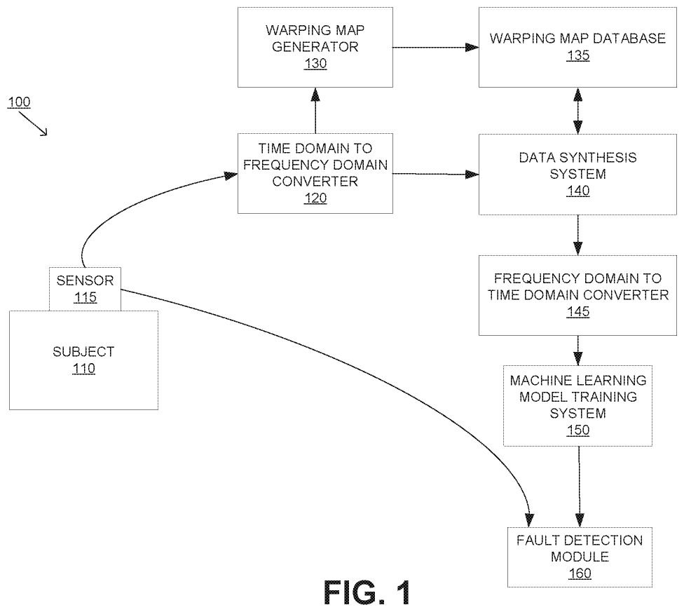

FIG. 1 is a block diagram illustrating an example system 100 for generating synthetic frequency domain data for a target state, in accordance with embodiments. System 100 includes subject 110 coupled to sensor 115, time domain to frequency domain converter 120, warping map generator 130, warping map database 135, data synthesis system 140, frequency domain to time domain converter 145, and machine learning model training system 150. In some embodiments, system 100 also includes fault detection module 160. It should be appreciated that time domain to frequency domain converter 120, warping map generator 130, warping map database 135, data synthesis system 140, frequency domain to time domain converter 145, and machine learning model training system 150, and fault detection module 160 can be implemented as hardware, software, or any combination thereof. It should also be appreciated that time domain to frequency domain converter 120, warping map generator 130, warping map database 125, data synthesis system 140, frequency domain to time domain converter 145, and machine learning model training system 150, and fault detection module 160 may be separate components, may be comprised within a single component, or may be comprised in various combinations of multiple components, in accordance with some embodiments.

Subject 110 is equipment or machinery that moves during operation such that data can be collected by sensor 115. It should be appreciated that subject 110 can be any time of industrial machine or equipment for which sensor time-series data can be captured, including but not limited to mechanical systems, rotor-bearing systems, motors, pumps, motors, industrial machines, etc. In some embodiments, the sensor time-series data collected by sensor 115 includes at least one of: vibration data, magnetic data, temperature data, pressure data, electric current data, and acoustic data. Subject 110 is capable of operating in different operating states (e.g., speed). For example, where subject 110 is a rotor-bearing system or a motor, subject 110 is capable of operating at different rotational speeds (e.g., 100 revolutions per minute (RPM), 110 RPM, 120 RPM, etc.), where each different rotational speed is a different operating state.

Sensor 115 is coupled to subject 110, and is capable of sensing vibrations from subject 110 and capturing the vibrations as time-series data. It should be appreciated that, in some embodiments, sensor 115 is not directly coupled to subject 110, but rather in the same environment as subject 110 (e.g., factory floor or industrial complex) and is capable of sensing motion and vibrations from subject 110. Sensor 115 captures time-series data when subject 110 is in different and distinct operating states. For instance, sensor 115 captures time-series data while subject 110 is operating under normal operating conditions (e.g., is in a healthy operating state) and while subject 110 is operating under faulty operating conditions (e.g., is in a faulty operating state). As used herein, a “healthy” system refers to a system that is operating under normal operating conditions and a “faulty” system refers to a system that is operating under faulty operating conditions and is in a state of failure for purposes of performing its intended operations.

Sensor 115 is a sensor for recording time-series data, including without limitation: physiological sensors (e.g., electroencephalogram (EEG) or electrocardiogram (ECG) sensor), a gyroscope, an accelerometer, a magnetometer, a seismic sensor, a microphone, and/or other motion sensors such as a pressure sensor and/or an ultrasonic sensor. It should be appreciated that sensor 115 can be any type of sensor capable of sensing vibrations and generating vibration data. In some embodiments, sensor 115 is comprised within a sensor processing unit (SPU). In various embodiments, sensor 115 is communicatively coupled with time domain to frequency domain converter 120, warping map generator 130, and/or data synthesis system 140 via a wired or wireless interface, or other well-known means. In some embodiments, sensor 115 is communicatively coupled with fault detection module 160 via a wired or wireless interface, or other well-known means.

Time domain to frequency domain converter 120 receives sensor time-series data (e.g. from sensor 115) and convert the sensor time-series data into frequency domain data. In some embodiments, time domain to frequency domain converter 120 is configured to perform a Fast Fourier Transform (FFT) operation on the sensor time-series data to generate frequency domain data. It should be appreciated that time domain to frequency domain converter 120 can be a standalone component or can be integrated directly within warping map generator 130 and/or data synthesis system 140.

Warping map generator 130 is configured to receive frequency domain data (e.g., from a standalone or integrated time domain to frequency domain converter 120) and generate pair-wise warping maps between frequency domain data associated with two different operating states of subject 110.

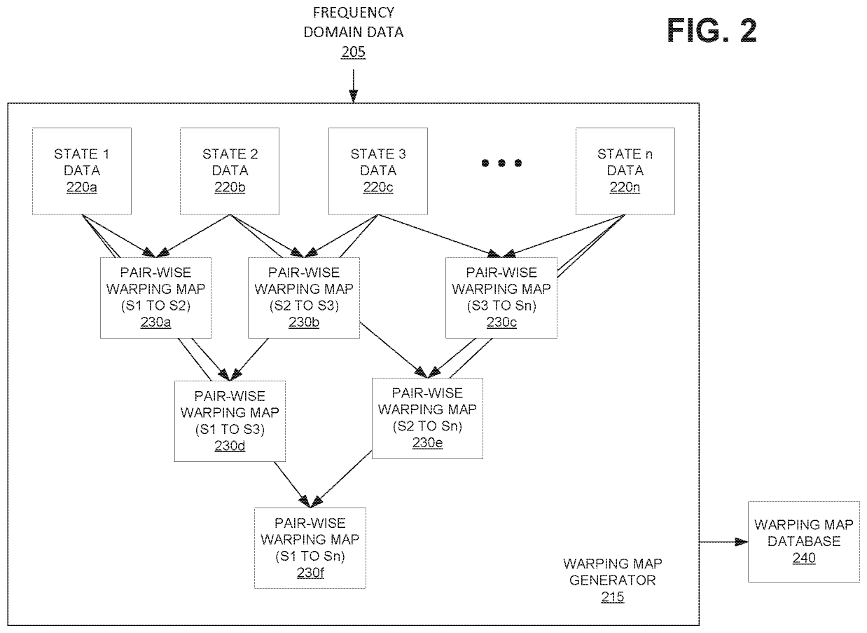

FIG. 2 is a block diagram of an example warping map generator 215, in accordance with embodiments. Warping map generator 215 may be implemented as warping map generator 130, according to some embodiments. Warping map generator 215 is configured to generate pair-wise warping maps between local regions of frequency domain data for different states of a subject (e.g., subject 110). A pair-wise warping map (also referred to herein as a “warping map”) of frequency domain data is a mapping between local regions of frequency domain data. A warping map allows for the transformation of frequency domain data from a query state (e.g., an input state) to a target state by applying the warping map to frequency domain date of the query state.

Frequency domain data 205 is received at warping map generator 215. In some embodiments, frequency domain data 205 is received from a sensor capable of generating frequency domain data from sensed time-series data. In some embodiments, frequency domain data 205 is received from a time domain to frequency domain converter (e.g., time domain to frequency domain converter 120 of FIG. 1). Frequency domain data 205 for multiple states is received, illustrated as State 1 data 220a, State 2 data 220b, State 3 data 220c, and State n data 230n. It should be appreciated that frequency domain data for any number of states can be received, as indicated as 1 to n states. In accordance with various embodiments, frequency domain data 205 is based four seconds or less of time-domain data, which is generally small amount of sensed data, relative to the amount of time-domain data available.

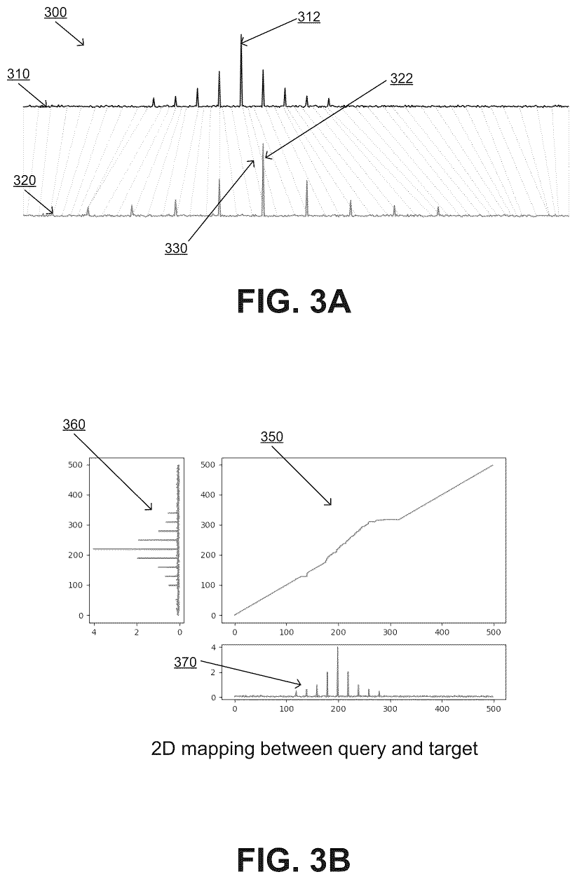

FIGS. 3A and 3B are graphs illustrating example warping maps between two states, in accordance with embodiments. FIG. 3A illustrates a warping map 300 between local regions of query state 310 to local regions of target state 320. Warping map 300 maps frequency responses, e.g., the “spikes” of query state 310 and target state 320, to each other. For example, mapping 330 maps frequency response 312 of query state 310 to frequency response 322 of target state 320. It should be appreciated that warping map 300 is reversable, such that query state 310 maps to target state 320 and targets state 320 maps to query state 310, for using warping map 300 to generate synthetic frequency domain data.

FIG. 3B illustrates a two-dimensional (2D) warping map 350 between query state 360 maps to target state 370. 2D warping map 350 shows precisely how each index in query state 360 maps to each index in target state 370. If multiple indices from the same query state 360 map to a single target state 370, it shows up as a convex peak in warping map 350. For a perfect 1:1 mapping between query state 360 and target state 370, 2D warping map 350 would show a straight line at 45 degrees with respect to the horizontal.

With reference to FIG. 2, warping map generator 215 is configured to generate pair-wise warping maps between all states of frequency domain data 205. Specifically, warping map generator 215 is configured to generate pair-wise warping map 230a that maps State 1 data 220a to State 2 data 220b, generate pair-wise warping map 230b that maps State 2 data 220b to State 3 data 220c, generate pair-wise warping map 230c that maps State 3 data 220c to State n data 220n, generate pair-wise warping map 230d that maps State 1 data 220a to State 3 data 220c, generate pair-wise warping map 230e that maps State 2 data 220b to State n data 220n, and generate pair-wise warping map 230f that maps State 1 data 220a to State n data 220n.

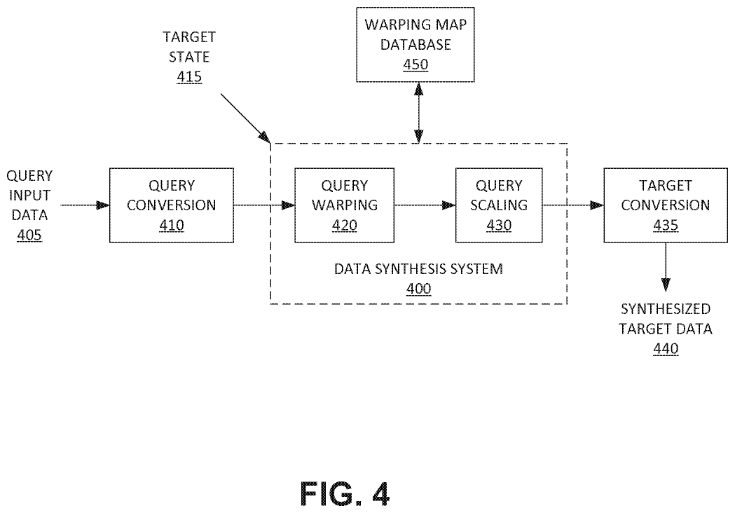

Pair-wise warping maps 230a through 230f are stored within warping map database 240 (e.g., warping map database 135 of FIG. 1) for access by a data synthesis system (e.g., data synthesis system 140 of FIG. 4).

With reference to FIG. 1, data synthesis system 140 is configured to receive frequency domain data (e.g. from sensor 115 and/or time domain to frequency domain converter 120), also referred to as “query state” data or “input state” data and generate synthetic frequency domain data for a target state by applying the received frequency domain data to a warping map. FIGS. 4 through 6 illustrate example data synthesis systems for generating synthetic frequency domain data according to various embodiments.

FIG. 4 is a block diagram illustrating an example data synthesis system 400 for synthesizing target data 440 by accessing a warping map database 450, in accordance with embodiments. It should be appreciated that data synthesis system 400 is an example embodiment of data synthesis system 140 of FIG. 1.

Query input data 405 is data of an input state of a subject. In some embodiments, query input data 405 is time-series data. In other embodiments, query input data 405 is received as frequency domain data. Where query input data 405 is received as time-series data, query input data 405 is received at query conversion module 410, where query conversion module 410 is configured to convert query input data 405 from time-series data to frequency domain data. It should be appreciated that query conversion module 410 can perform any operation (e.g., an FFT operation) on query input data 405 to convert query input data 405 from time-series data to frequency domain data. Moreover, it should be appreciated that, in some embodiments, query conversion module 410 may be integrated into data synthesis system 400, rather than being a separate module.

Data synthesis system 400 receives frequency domain query input data 405 and an identification of target state 415, where target state 415 is the state for which synthetic frequency domain data is to be generated. Data synthesis system 400 accesses a warping map from warping map database 450 that corresponds to a mapping between the input state of query input data 405 and target state 415.

At query warping module 420, frequency domain query input data 405 is applied to the warping map accessed from warping map database 450 that corresponds to a mapping between the input state of query input data 405 and target state 415. By applying the retrieved warping map to frequency domain query input data 405, frequency domain query input data 405 is mapped to target state 415, resulting in frequency domain data at target state 415. In this way, an instance (e.g., a local region) of frequency domain input data 405 is transformed into the corresponding target state by mapping that instance of frequency domain input data 405 to the corresponding instance (e.g., local region) of target state 415.

Amplitudes of frequency domain data can vary at different states. In some embodiments, a scaling factor is applied to the synthetic frequency domain data after warping to appropriately scale the amplitude of the frequency domain data at target state 415, where the scaling factor is associated with the query input state and the target state. The scaling factor is a ratio of amplitudes of the frequency domain data between the input state and target state 415.

Query scaling module 430 receives the frequency domain data at target state 415 from query warping module 420 and applies a scaling factor to the frequency domain data at target state 415. In some embodiments, the scaling factor is stored within warping map database 450 and accessed along with the warping map that corresponds to a mapping between the input state of query input data 405 and target state 415. Synthesized target data is output from data synthesis module 400 after warping and scaling is performed, where the synthesized target data is synthetic frequency domain data.

In some embodiments, the synthesized target data is converted to time-series data at target conversion module 435, e.g., for use in training a machine learning model on time-series data. It should be appreciated that target conversion module 435 can perform any operation (e.g., an inverse FFT operation) on the synthesized target data to convert the synthesized target data from frequency domain data to time-series data. Moreover, it should be appreciated that, in some embodiments, target conversion module 435 may be integrated into data synthesis system 400, rather than being a separate module. Synthesized time-series target data 440 is output from target conversion module 435.

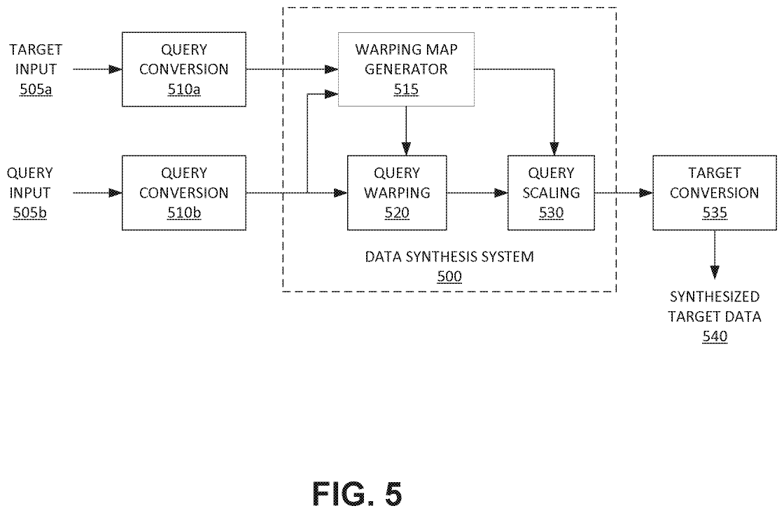

FIG. 5 is a block diagram illustrating an example data synthesis system 500 for synthesizing target data 540 by generating a warping map, in accordance with embodiments. It should be appreciated that data synthesis system 500 is an example embodiment of data synthesis system 140 of FIG. 1.

Query input data 505b is data of an input state of a subject. Target input data 505a is data of a target state of the subject. In some embodiments, target input data 505a and query input data 505b are time-series data. In other embodiments, target input data 505a and query input data 505b are received as frequency domain data. In some embodiments, target input data 505a includes much less data than query input data 505b. For example, target input data 505a may include four seconds or less of data, while query input data 505b can include many minutes, or more, of data.

Where target input data 505a and query input data 505b are received as time-series data, target input data 505a is received at query conversion module 510a and query input data 505b is received at query conversion module 510b, where query conversion modules 510a and 510b are configured to convert target input data 505a and query input data 505b from time-series data to frequency domain data. It should be appreciated that query conversion modules 510a and 510b can perform any operation (e.g., an FFT operation) on target input data 505a and query input data 505b, respectively, to convert target query data 505a and query input data 505b from time-series data to frequency domain data. Moreover, it should be appreciated that, in some embodiments, query conversion modules 510a and/or 510b may be integrated into data synthesis system 500, rather than separate modules. In some embodiments, query conversion modules 510a and 510b are comprised within a single query conversion module capable of converting both target input data 505a and query input data 505b from time-series data to frequency domain data.

Data synthesis system 500 receives frequency domain target input data 505a and frequency domain query input data 505b, where target input data 505a identifies the target state for which synthetic frequency domain data is to be generated. Frequency domain target input data 505a and frequency domain query input data 505b are received at warping map generator 515. Warping map generator 515 generates a pair-wise warping map between the state of target input data 505a and query input data 505b (e.g., as described with reference to FIG. 2).

At query warping module 520, frequency domain query input data 505b is applied to the warping map generated at warping map generator 515. By applying the generated warping map to frequency domain query input data 505b, frequency domain query input data 505b is mapped to the target state, resulting in frequency domain data at the target state. In this way, an instance (e.g., a local region) of frequency domain input data 505b is transformed into the corresponding target state by mapping that instance of frequency domain input data 505b to the corresponding instance (e.g., local region) of the target state.

In some embodiments, a scaling factor is applied to the synthetic frequency domain data after warping to appropriately scale the amplitude of the frequency domain data at the target state, where the scaling factor is associated with the query input state and the target state. The scaling factor is a ratio of amplitudes of the frequency domain data between the input state and the target state.

In some embodiments, query scaling module 530 receives the frequency domain data at the target state from query warping module 520 and applies a scaling factor to the frequency domain data at the target state. In some embodiments, the scaling factor is generated within warping map generator 515 and accessed along with the generated warping map that corresponds to a mapping between the input state of query input data 505b and target state of target input data 505a. In other embodiments, the scaling factor is generated at query scaling module 530 based on query input data 505b and target input data 505a. Synthesized target data is output from data synthesis module 500 after warping and scaling is performed, where the synthesized target data is synthetic frequency domain data.

In some embodiments, the synthesized target data is converted to time-series data at target conversion module 535, e.g., for use in training a machine learning model on time-series data. It should be appreciated that target conversion module 535 can perform any operation (e.g., an inverse FFT operation) on the synthesized target data to convert the synthesized target data from frequency domain data to time-series data. Moreover, it should be appreciated that, in some embodiments, target conversion module 535 may be integrated into data synthesis system 500, rather than being a separate module. Synthesized time-series target data 540 is output from target conversion module 535.

In some embodiments, synthetic frequency domain target data is generated from multiple frequency domain query inputs at different states (e.g., different speeds). For example, the synthetic frequency domain target generated using different frequency domain query inputs may be different from each other, or at least include some different instances, as they were generated using different data captured at different states. In such cases, the multiple generated synthetic frequency domain target data can be blended together (e.g., merged) to generate a single blended frequency domain target data.

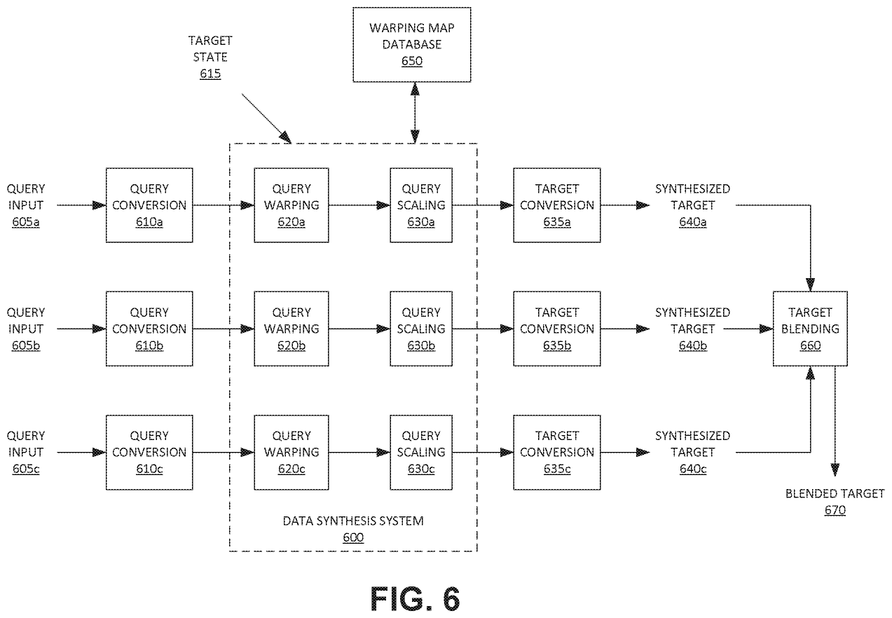

FIG. 6 is a block diagram illustrating an example data synthesis system 600 for synthesizing target data using multiple query inputs 605a, 605b, and 605c, and blending the candidate synthesized target data 640a, 640b, and 640c into blended target data 670, in accordance with embodiments. It should be appreciated that data synthesis system 600 is an example embodiment of data synthesis system 140 of FIG. 1.

Query input data 605a, 605b, and 605c are data inputs at different input states of a subject. For example, query input data 605a, 605b, and 605c are inputs of sensing a rotational motor at different speeds (e.g., 100 RPM, 110 RPM, and 120 RPM). In some embodiments, query input data 605a, 605b, and 605c are time-series data. In some embodiments, query input data 605a, 605b, and 605c are time-series data. In other embodiments, query input data 605a, 605b, and 605c are received as frequency domain data.

Where query input data 605a, 605b, and 605c are received as time-series data, query input data 605a is received at query conversion module 610a, query input data 605b is received at query conversion module 610b, and query input data 605c is received at query conversion module 610c, where query conversion modules 610a, 610b, and 610c are configured to convert query input data 605a, 605b, and 605c from time-series data to frequency domain data. It should be appreciated that query conversion modules 610a, 610b, and 610c can perform any operation (e.g., an FFT operation) on query input data 605a, 605b, and 605c, respectively, to convert query input data 605a, 605b, and 605c from time-series data to frequency domain data. Moreover, it should be appreciated that, in some embodiments, query conversion modules 610a, 610b, and/or 610c may be integrated into data synthesis system 600, rather than separate modules. In some embodiments, query conversion modules 610a, 610b, and/or 610c are comprised within a single query conversion module capable of converting query input data 605a, 605b, and 605c from time-series data to frequency domain data.

Data synthesis system 600 receives frequency domain query input data 605a, 605b, and 605c, and an identification of target state 615, where target state 615 is the state for which synthetic frequency domain data is to be generated. For example, query input data 605a, 605b, and 605c are inputs of sensing a rotational motor at different speeds (e.g., 100 RPM, 110 RPM, and 120 RPM) and target state 615 is 115 RPM. Data synthesis system 600 accesses a warping map from warping map database 650 that corresponds to a mapping between the input state of each of query input data 605a, 605b, and 605c and target state 615. In the example, data synthesis system would access warping maps for mapping 100 RPM to 115 RPM, 110 RPM to 115 RPM, and 120 RPM to 115 RPM.

For instance, at query warping module 620a, frequency domain query input data 605a is applied to the warping map accessed from warping map database 650 that corresponds to a mapping between the input state of query input data 605a and target state 615. By applying the retrieved warping map to frequency domain query input data 605a, frequency domain query input data 605a is mapped to target state 615, resulting in frequency domain data at target state 615. In this way, an instance (e.g., a local region) of frequency domain input data 605a is transformed into the corresponding target state by mapping that instance of frequency domain input data 605a to the corresponding instance (e.g., local region) of target state 615.

It should be appreciated that query mapping modules 620b and 620c operate in a similar manner as query warping module 620a, where frequency domain query input data 605b is applied to the warping map accessed from warping map database 650 that correspond to a mapping between the input state of query input data 605b and target state 615, and frequency domain query input data 605c is applied to the warping map accessed from warping map database 650 that correspond to a mapping between the input state of query input data 605c and target state 615. By applying the retrieved warping maps to frequency domain query input data 605b and 605c, frequency domain query input data 605b is mapped to target state 615 and frequency domain query input data 605c is mapped to target state 615, resulting in two synthesized frequency domain data at target state 615.

In some embodiments, a scaling factor is applied to the synthetic frequency domain data after warping to appropriately scale the amplitude of the frequency domain data at the target state, where the scaling factor is associated with the query input state and the target state. The scaling factor is a ratio of amplitudes of the frequency domain data between the input state and the target state.

In some embodiments, query scaling modules 630a, 630b, and 630c receive the frequency domain data at the target state from query warping module 620a, 620b, and 620c, respectively, and applies a scaling factor to the frequency domain data at target state 615 to each of the frequency domain data. In some embodiments, the scaling factor is generated within warping map database 650 and accessed along with the warping maps that corresponds to mappings between the frequency domain query input data 605a, 605b, and 605c, and target state 615. Synthesized target data is output from data synthesis module 600 after warping and scaling is performed, where the synthesized target data is synthetic frequency domain data.

In some embodiments, the synthesized target data is converted to time-series data at target conversion modules 635a, 635b, and 635c, e.g., for use in training a machine learning model on time-series data. It should be appreciated that target conversion modules 635a, 635b, and 635c can perform any operation (e.g., an inverse FFT operation) on the synthesized target data to convert the synthesized target data from frequency domain data to time-series data. Moreover, it should be appreciated that, in some embodiments, target conversion modules 635a, 635b, and 635c may be integrated into data synthesis system 600, rather than being a separate module. Synthesized target data 640a, 640b, and 640c is output from target conversion modules 635a, 635b, and 635c, respectively, where synthesized target data 640a, 640b, and 640c are synthetic time-series domain data.

Target blending module 660 receives synthesized target data 640a, 640b, and 640c for blending synthesized target data 640a, 640b, and 640c into a single synthesized blended target 670. For example, target blending module 660 may operate according to blending equation.

$${FFT}_{target} = {\sum }_{k = 1}^{K} {α}_{k} MAP ( {FFT}_{query}^{k} )$$

where, FFT_{target} is blended target, K is the total number of query inputs to be blended (e.g., three in FIG. 6),

$$MAP ( {FFT}_{query}^{k} )$$

is the warped query computed using the corresponding warping map, and αₖ is the weight applied to the k^{th} warped query.

In some embodiments, a naïve blending is used, where all synthesized target data 640a, 640b, and 640c are averaged into blended target 670, wherein each of synthesized target data 640a, 640b, and 640c is weight equally. For example, αₖ=1/K.

In some embodiments, heuristic blending is used, where a gradient is applied to the weights such that query states (S_{query}) farther from the target state (S_{target}) are weighted lower than those closer to the target speed. For example,

$${α}_{k} = \frac{{β}_{k}}{{\sum }_{i = 1}^{K} {β}_{i}} , where {β}_{k} = \frac{{S}_{query}}{{S}_{target}}$$

where βₖ is the state ratio between states (e.g., a speed ratio). In such embodiments, weights for each of synthesized target data 640a, 640b, and 640c are determined based on a relative distance of each associated query input data 605a, 605b, and 605c from the target state.

In some embodiments, statistical modeling is used for blending, such as linear or logistic regression, to estimate the weights. In such embodiments, weights for each of synthesized target data 640a, 640b, and 640c are estimated based on statistical modeling.

Target blending module 660 applies weights to each of synthesized target data 640a, 640b, and 640c, e.g., naïve blending or heuristic blending, for generating blended target 670, where blended target 670 includes synthetic frequency domain data at target state 615.

With reference to FIG. 1, in some embodiments, the synthesized target data is converted to time-series data at frequency domain to time domain converter 145, e.g., for use in training a machine learning model on time-series data. It should be appreciated that frequency domain to time domain converter 145 can perform any operation (e.g., an inverse FFT operation) on the synthesized target data to convert the synthesized target data from frequency domain data to time-series data. Moreover, it should be appreciated that, in some embodiments, frequency domain to time domain converter 145 may be integrated into data synthesis system 140, rather than being a separate module. Synthesized time-series target data is output from frequency domain to time domain converter 145.

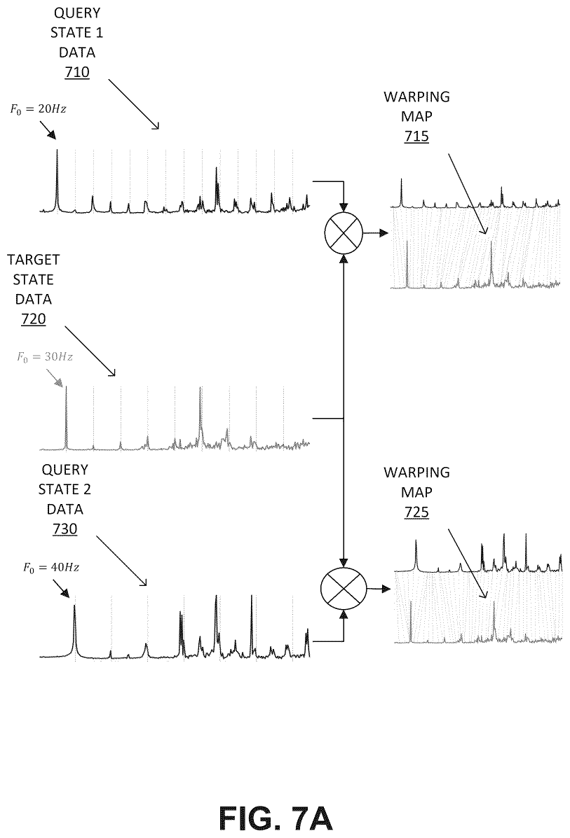

FIGS. 7A and 7B illustrate schematics of example graphs for mapping frequency domain query data into synthetic frequency domain target data and blending the frequency domain target data for corresponding to the states of the query data into a blended synthetic frequency domain target data. It should be appreciated that any number of input query states can be mapped into target state data and blended to generate blended synthetic frequency domain target data, and that FIGS. 7A and 7B are an example using two input query states.

FIG. 7A are graphs illustrating example warping map generation, in accordance with embodiments. As illustrated query state 1 data 710, including frequency domain data at 20 Hz, query state 2 data 730, including frequency domain data at 40 Hz, and target state data 720, including frequency domain data at 30 Hz is received (e.g., at data synthesis system 140 of FIG. 1). In accordance with embodiments, target state data 720 includes significantly less data than query state 1 data 710 and query state 2 data 730. For example, target state data 720 may include four seconds or less of data, while query state 1 data 710 and query state 2 data 730 may include five minutes or more of data.

Warping map 715 is generated (e.g., at warping map generator 130 of FIG. 1) or accessed (e.g., from warping map database 135 of FIG. 1), where warping map 715 is for mapping between local regions of state 1 (20 Hz) and the target state (30 Hz). Similarly, warping map 715 is generated (e.g., at warping map generator 130 of FIG. 1) or accessed (e.g., from warping map database 135 of FIG. 1), where warping map 725 is for mapping between local regions of state 2 (40 Hz) and the target state (30 Hz).

FIG. 7B are graphs illustrating an example blending operation, continuing the example of FIG. 7A, in accordance with embodiments. Applying warping map 715 to query state 1 data 710 generates synthetic target data 750 by mapping query state 1 data 710 from 20 Hz to the target state of 30 Hz. Applying warping map 725 to query state 2 data 730 generates synthetic target data 760 by mapping query state 2 data 730 from 40 Hz to the target state of 30 Hz.

It should be noted that, while synthetic target data 750 and synthetic target data 760 include synthetic frequency domain data at 30 Hz, synthetic target data 750 and synthetic target data 760 include differences between each other due to the different input data states of query state 1 data 710 and query state 2 data 730. For instance, region 752 of synthetic target data 750 and region 762 of synthetic target data 760 include different data that is visually apparent. To minimize any impact of the discrepancies between region 752 and 762, synthetic target data 750 and synthetic target data 760 are blended (e.g., using averaging, heuristic blending, or statistical modeling) to generate blended synthetic target data 770. As illustrated, the differences illustrated at regions 752 and 762 are reduced, as shown at regions 772 and 774 as a result of the blending.

Embodiments described herein allow for the synthesis of frequency domain target data across multiple subjects. Where two subjects are sufficiently similar (e.g., the same type or model of machine at similar operating conditions), warping maps generated for a first subject can be applied to a second subject for generating synthesized target data without the need for generating warping maps for the second subject. Such an embodiment saves processing time and data acquisition time for the second subject, thereby improving the efficiency of synthetic target data generation.

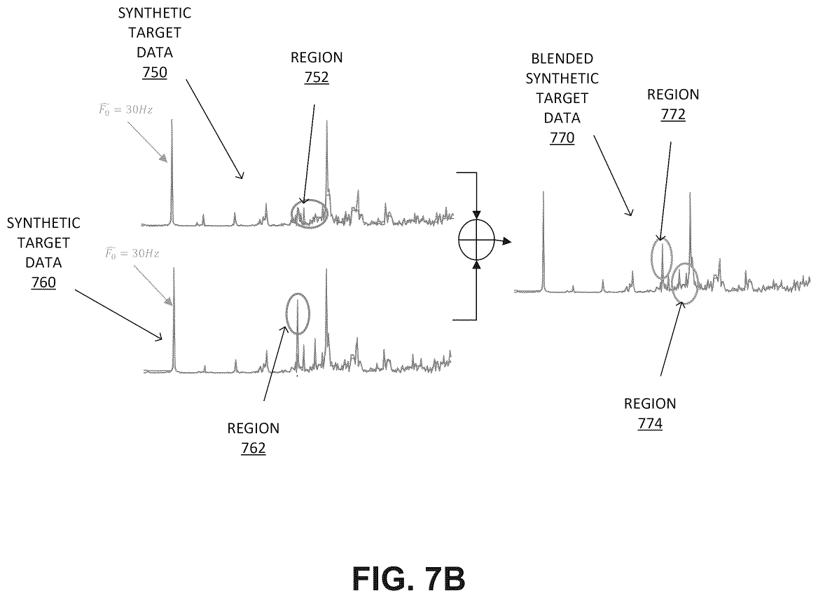

FIG. 8 is a block diagram illustrating an example system 800 for generating frequency domain data for a second subject based on warping maps for a first subject, in accordance with embodiments. Subject 1 data 805 at state X and subject 2 data 808 at state X are received at warping map generator 810. In some embodiments, subject 1 data 805 is received from warping map database 820. Warping map generator 810 generates warping map 830 based on subject 1 data 805 and subject 2 data 808, where warping map 830 includes a pair-wise mapping of local regions of subject 1 data 805 to subject 2 data 808 at state X. Warping map 830 is stored in warping map database 820.

Using warping map 830, that maps subject 1 data 805 and subject 2 data 808 at state X, and warping maps for subject 1 825, that includes mappings between multiple states of subject 1, data synthesis system 850 is able to generate synthetic frequency domain target data at multiple states of subject 2. For example, data synthesis system 850 receives subject 2 data 808 and subject 2 target state 845. Using subject 2 data 808 and subject 2 target state 845, data synthesis system 850 is configured to generate synthetic target data for subject 2 860 by applying subject 2 data 808 to subject 1 using warping map 830, and then applying the warping map of warping maps for subject one 825 that corresponds to mapping to subject 2 target state 845.

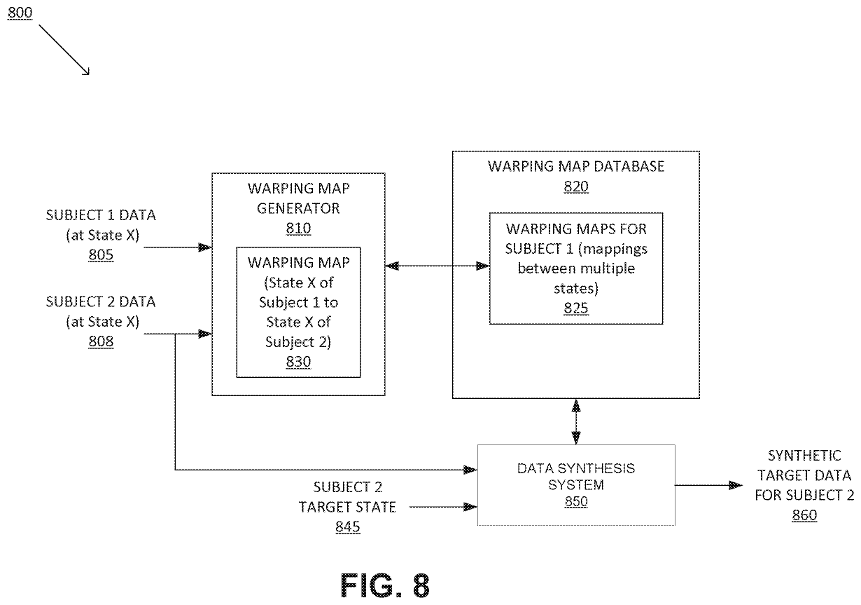

FIG. 9 is a block diagram illustrating an example machine learning model training system 920 (e.g., machine learning model training system 150 of FIG. 1), in accordance with embodiments. Machine learning model training system 920 is configured to train machine learning model 930 using synthetic target data 910. In some embodiments, synthetic target data 910 is time-series data based on converting from synthetic frequency domain data, as described various embodiments herein. In some embodiments, synthetic target data 910 is frequency domain data.

Machine learning model 930 can be deployed (e.g., to receive sensor data from subject 110 of FIG. 1) to perform fault detection on subject 110. The described embodiments provide for meaningful training of machine learning model 930 by generating synthetic target data 930 representing an operating state of subject 110 without requiring generation of actual data for the operating state of subject 110. It should be appreciated that machine learning model training system 920 can train any number of machine learning models 930, with each being trained to identify a particular state.

In some embodiments, machine learning model 930 is configured to perform at least one of: anomaly detection, prediction of future values, or classification of an operating state of the system. In some embodiments, machine learning model 930 is a condition-based monitoring (CBM) machine learning model for predictive maintenance of a subject (e.g., subject 110) by enabling fault detection and failure forecasting.

With reference to FIG. 1, in some embodiments, system 100 also includes fault detection module 160 including a proxy machine learning model to perform the fault detection on subject 110 on collected sensor time-series data.

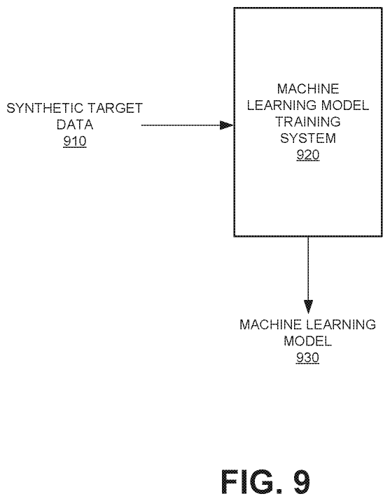

FIG. 10 is a block diagram illustrating example fault detection module 1010 (e.g., fault detection module 160 of FIG. 1), in accordance with embodiments. Fault detection module 1010 includes machine learning model 930, which is trained to identify perform fault detection on subject 110 at a particular operating state. It should be appreciated that fault detection module 1010 can include any number of machine learning models 930, with each being trained to monitor performance at a particular state.

Machine learning model 930 receives sensor data 1005. In some embodiments, sensor data 1005 is time-series data. In other embodiments, sensor data 1005 is frequency domain data. In some embodiments, where sensor data 1005 is time-series data and where machine learning model 930 is trained on frequency domain data, sensor data 1005 is first transformed into frequency domain data (e.g., using time domain to frequency domain converter 120 of FIG. 1). In other embodiments, wherein sensor data 1005 is frequency domain data and where machine learning model 930 is trained on time domain data, sensor data 1005 is first transformed into time domain data (e.g., using frequency domain to time domain converter 145 of FIG. 1).

It should be appreciated that sensor data 1005 can be received from a sensor (e.g., sensor 115) or from another sensor in the target environment. Machine learning model 930 performs fault detection and diagnosis on sensor data 1005, and generates fault detection determination 1020 (e.g., the system is healthy and operating under normal conditions, the system is experiencing a fault event, or the system is experiencing a partial fault event).

### Example Methods of Operation

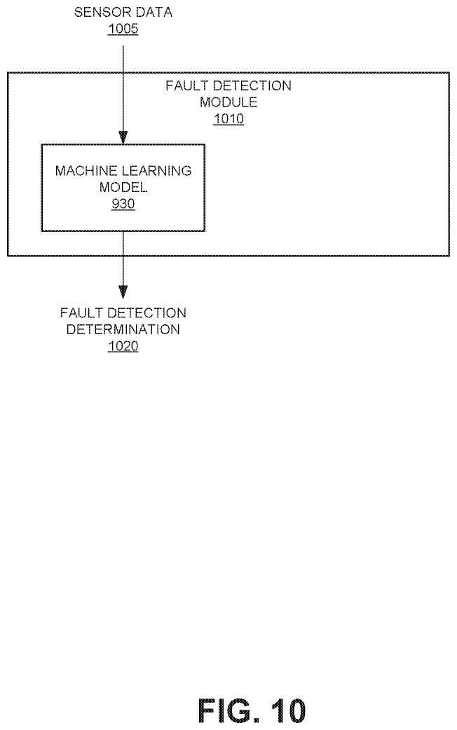

The following discussion sets forth in detail the operation of some example methods of operation of embodiments. With reference to FIGS. 11 through 15, flow diagrams 1100, 1200, 1300, 1400, and 1500, illustrate example procedures used by various embodiments. Flow diagrams 1100, 1200, 1300, 1400, and 1500 include some procedures that, in various embodiments, are carried out by a processor under the control of computer-readable and computer-executable instructions. In this fashion, procedures described herein and in conjunction with the flow diagrams are, or may be, implemented using a computer, in various embodiments. The computer-readable and computer-executable instructions can reside in any tangible computer readable storage media. Some non-limiting examples of tangible computer readable storage media include random access memory, read only memory, magnetic disks, solid state drives/“disks,” and optical disks, any or all of which may be employed with computer environments. The computer-readable and computer-executable instructions, which reside on tangible computer readable storage media, are used to control, or operate in conjunction with, for example, one or some combination of processors of the computer environments and/or virtualized environment. It is appreciated that the processor(s) may be physical or virtual or some combination (it should also be appreciated that a virtual processor is implemented on physical hardware). Although specific procedures are disclosed in the flow diagram, such procedures are examples. That is, embodiments are well suited for performing various other procedures or variations of the procedures recited in the flow diagram. Likewise, in some embodiments, the procedures in the flow diagram may be performed in an order different than presented and/or not all the procedures described in the flow diagram may be performed. It is further appreciated that procedures described in the flow diagrams may be implemented in hardware, or a combination of hardware with firmware and/or software provided by a computer system.

FIG. 11 is a flow diagram 1100 illustrating an example method for generating synthetic frequency domain data, according to embodiments. In some embodiments, as shown at procedure 1110 of flow diagram 1100, time domain data is first received for the input state and the target state. At procedure 1120, the time domain data for the input state and the target state is transformed into the frequency domain data for the input state and the target state.

At procedure 1130 of flow diagram 1100, frequency domain data for an input state and a target state for a subject is received, wherein the frequency domain data exhibits morphologically dominant periodicity. In some embodiments, the subject is a machine and wherein the input state and the target state are different operating speeds of the machine. In some embodiments, a change from the input state to the target state at the subject is sensed. Responsive to the sensing the change, frequency domain data for the target state for the subject is automatically collected.

At procedure 1140, a warping map between local regions of the frequency domain data for the input state and the target state is generated. In some embodiments, the warping map is stored at a map database, wherein the map database comprises a plurality of warping maps for different input states and target states.

At procedure 1150, synthetic frequency domain data at the target state is generated based at least in part on applying the frequency domain data for the input state to the warping map. In some embodiments, as shown at procedure 1160, a scaling factor is applied to the synthetic frequency domain data, wherein the scaling factor is a ratio of amplitudes of the frequency domain data between the input state and the target state. In some embodiments, as shown at procedure 1170, the synthetic frequency domain data at the target state is transformed into synthetic time domain data at the target state.

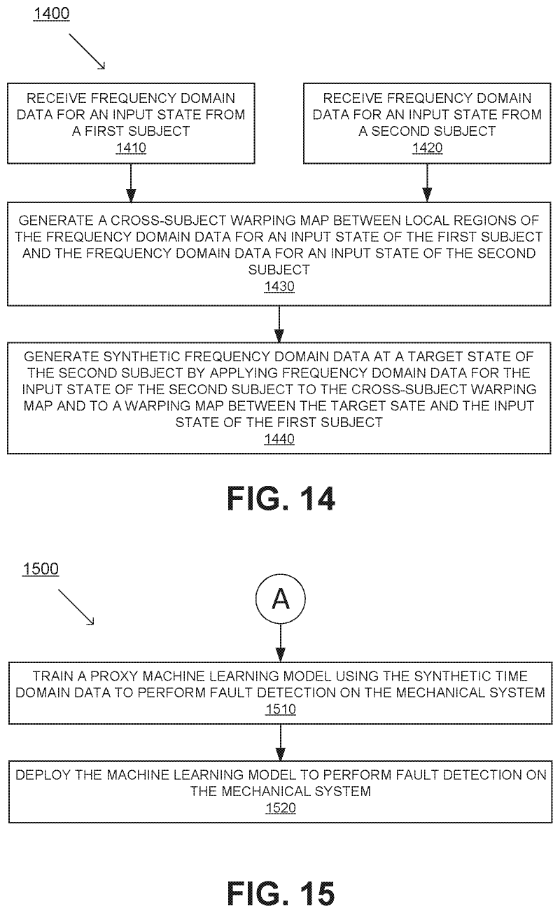

In some embodiments, flow diagram 1100 proceeds to flow diagram 1500 of FIG. 15.

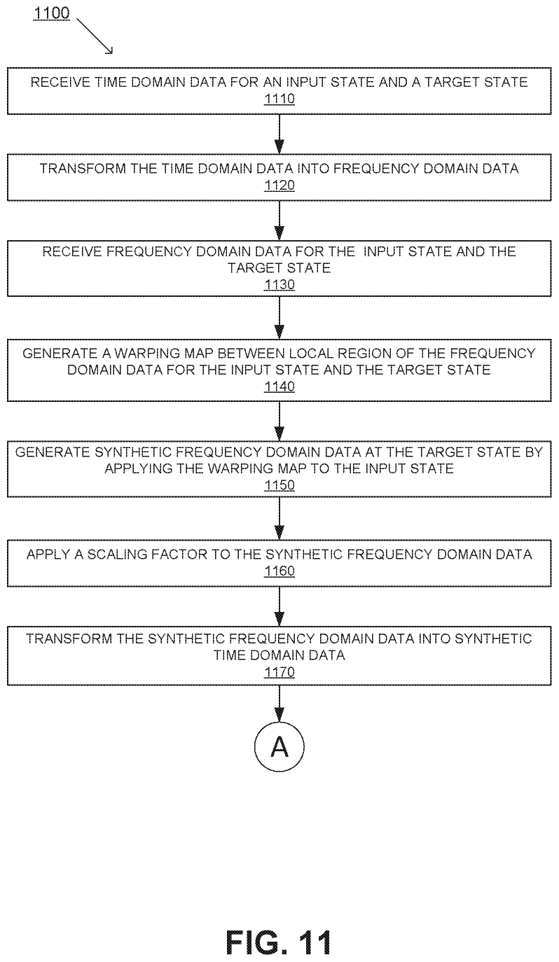

FIG. 12 is a flow diagram 1200 illustrating another example method for generating synthetic frequency domain data, according to embodiments. Embodiments described herein provide a method for synthesizing frequency domain data for a target state. In some embodiments, as shown at procedure 1210 of flow diagram 1200, time domain data is first received for the input state. At procedure 1215, a target state is received, where the target state identifies a target state for which synthetic frequency domain data is to be generated. At procedure 1220, the time domain data for the input state is transformed into the frequency domain data for the input state and the target state.

At procedure 1230 of flow diagram 1200, frequency domain data for the input state for a subject is received, wherein the frequency domain data exhibits morphologically dominant periodicity. In some embodiments, the subject is a machine and wherein the input state and the target state are different operating speeds of the machine.

At procedure 1240, a warping map between local regions of the frequency domain data for the input state and the target state is accessed. In some embodiments, the warping map is accessed at or retrieved from a map database, wherein the map database includes a plurality of warping maps for different input states and target states.

At procedure 1250, synthetic frequency domain data at the target state is generated based at least in part on applying the frequency domain data for the input state to the warping map. In some embodiments, as shown at procedure 1260, a scaling factor is applied to the synthetic frequency domain data, wherein the scaling factor is a ratio of amplitudes of the frequency domain data between the input state and the target state. In some embodiments, as shown at procedure 1270, the synthetic frequency domain data at the target state is transformed into synthetic time domain data at the target state.

In some embodiments, flow diagram 1200 proceeds to flow diagram 1500 of FIG. 15.

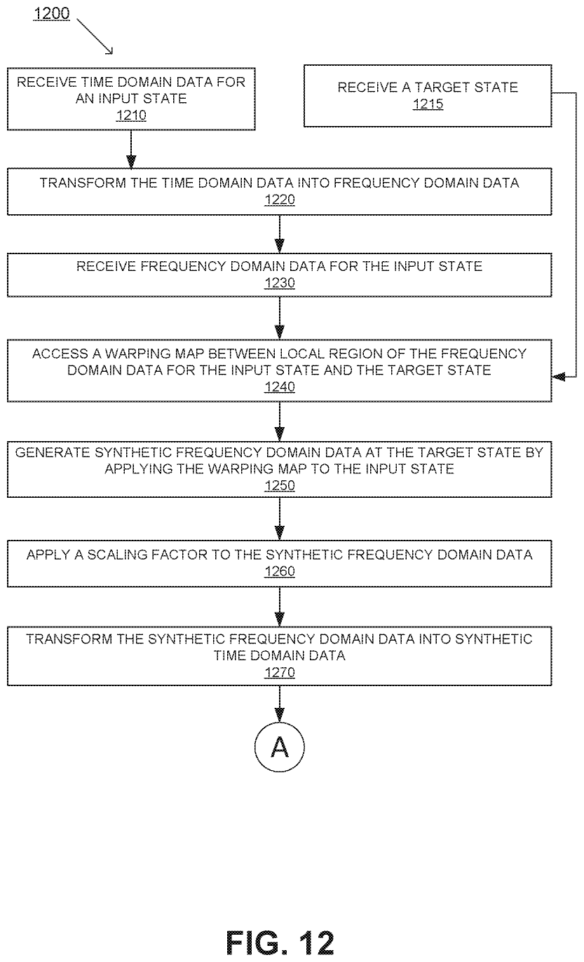

FIG. 13 is a flow diagram 1300 illustrating an example method for blending synthetic data, according to embodiments. In some embodiments, a plurality of instances of synthetic data for a target state are generated using different input states. In some embodiments, the plurality of instances of synthetic data for a target state are generated according to flow diagram 1100 of FIG. 11. In some embodiments, the plurality of instances of synthetic data for a target state are generated according to flow diagram 1200 of FIG. 12.

At procedure 1310, first synthetic data for a target state is received, and at procedure 1315, second synthetic data for the target state is received. In some embodiments, the first synthetic data and the second synthetic data include time-series data. In some embodiments, the first synthetic data and the second synthetic data include frequency domain data.

At procedure 1320, the first synthetic data and the second synthetic data are blended to generate blended synthetic frequency domain data. In some embodiments, as shown at procedure 1330, weights for the first synthetic data and the second synthetic data are determined. In some embodiments, as shown at procedure 1340, equal weights are assigned to the first synthetic data and the second synthetic data (e.g., the first synthetic data and the second synthetic data are averaged). In some embodiments, as shown at procedure 1342, weights for the first synthetic data and the second synthetic data are based at least in part on a relative distance from the target state. In some embodiments, as shown at procedure 1344, weights for the first synthetic data and the second synthetic data are based on statistical modeling.

At procedure 1350, the weights are applied to the first synthetic data and the second synthetic data to generate the blended synthetic frequency domain data.

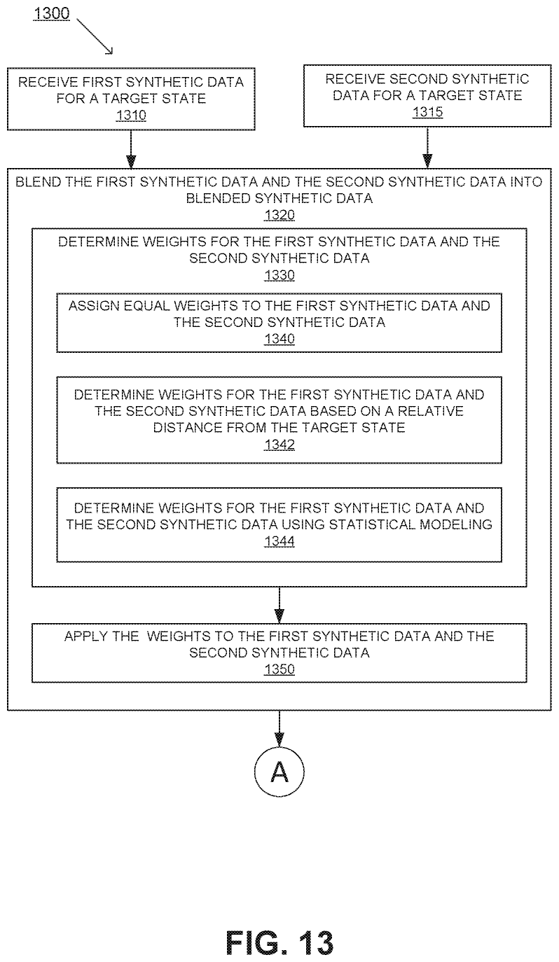

FIG. 14 is a flow diagram 1400 illustrating an example method for using a warping map generated for a first subject to generate synthetic frequency domain data for a second subject, according to embodiments. At procedure 1410 of flow diagram 1400, frequency domain data for an input state of a first subject is received. At procedure 1420, frequency domain data for an input state of a second subject is received. At procedure 1430, a cross-subject warping map between local regions of the frequency domain data for the input state of the first subject to the frequency domain data for the input state of the second subject is generated.

At procedure 1440, synthetic frequency domain data at a target state of the second subject is generated based at least in part on applying the frequency domain data for the input state of the second subject to the cross-subject warping map and to a warping map between the target state and the input state of the first subject.

FIG. 15 is a flow diagram 1500 illustrating an example method for performing condition-based monitoring at the subject operating at the target state, according to embodiments. At procedure 1510 of flow diagram 1500, a machine learning model is trained using the synthetic frequency domain data at the target state to perform condition-based monitoring at the subject operating at the target state. The machine learning model is a CBM machine learning model for predictive maintenance of the system by enabling fault detection and failure forecasting. In some embodiments, as shown at procedure 1520, the machine learning model is deployed to perform condition-based monitoring at the subject operating at the target state.

The examples set forth herein were presented in order to best explain, to describe particular applications, and to thereby enable those skilled in the art to make and use embodiments of the described examples. However, those skilled in the art will recognize that the foregoing description and examples have been presented for the purposes of illustration and example only. The description as set forth is not intended to be exhaustive or to limit the embodiments to the precise form disclosed. Rather, the specific features and acts described above are disclosed as example forms of implementing the claims.

Reference throughout this document to “one embodiment,” “certain embodiments,” “an embodiment,” “various embodiments,” “some embodiments,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

1. A method for synthesizing frequency domain data for a target state, the method comprising:
receiving frequency domain data for an input state and a target state for a subject, wherein the frequency domain data exhibits morphologically dominant periodicity;
generating a warping map between local regions of the frequency domain data for the input state and the target state; and
generating synthetic frequency domain data at the target state based at least in part on applying the frequency domain data for the input state to the warping map.

2. The method of claim 1, further comprising:
applying a scaling factor to the synthetic frequency domain data, wherein the scaling factor is a ratio of amplitudes of the frequency domain data between the input state and the target state.

3. The method of claim 1, further comprising:
receiving frequency domain data for a second input state;
generating a second warping map between local regions of the frequency domain data for the second input state and the target state; and
generating second synthetic frequency domain data at the target state based at least in part on applying the frequency domain data for the second input state to the second warping map.

4. The method of claim 3, further comprising:
blending the synthetic frequency domain data and the second synthetic frequency at the target state to generate blended synthetic frequency domain data.

5. The method of claim 4, wherein the blending the synthetic frequency domain data and the second synthetic frequency at the target state to generate the blended synthetic frequency domain data comprises:
averaging the synthetic frequency domain data and the second synthetic frequency domain data at the target state to generate the blended synthetic frequency domain data.

6. The method of claim 4, wherein the blending the synthetic frequency domain data and the second synthetic frequency at the target state to generate the blended synthetic frequency domain data comprises:
determining weights for the synthetic frequency domain data and the second synthetic frequency domain data at the target state based at least in part on a relative distance from the target state; and
applying the weights to the synthetic frequency domain data and the second synthetic frequency domain data to generate the blended synthetic frequency domain data.

7. The method of claim 4, wherein the blending the synthetic frequency domain data and the second synthetic frequency at the target state to generate the blended synthetic frequency domain data comprises:
using statistical modeling to estimate weights for the synthetic frequency domain data and the second synthetic frequency domain data at the target state; and
applying the weights to the synthetic frequency domain data and the second synthetic frequency domain data to generate the blended synthetic frequency domain data.

8. The method of claim 1, further comprising:
receiving time domain data for the input state and the target state; and
transforming the time domain data for the input state and the target state into the frequency domain data for the input state and the target state.

9. The method of claim 1, further comprising:
transforming the synthetic frequency domain data at the target state into synthetic time domain data at the target state.

10. The method of claim 1, wherein the subject is a machine and wherein the input state and the target state are different operating speeds of the machine.

11. The method of claim 1, further comprising:
receiving frequency domain data for an input state of a second subject; and
generating a cross-subject warping map between local regions of the frequency domain data for the input state of the subject to the frequency domain data for the input state of the second subject.

12. The method of claim 11, further comprising:
generating synthetic frequency domain data at a target state of the second subject based at least in part on applying the frequency domain data for the input state of the second subject to the cross-subject warping map.

13. The method of claim 1, further comprising:
training a machine learning model using the synthetic frequency domain data at the target state to perform condition-based monitoring at the subject operating at the target state.

14. The method of claim 13, further comprising:
deploying the machine learning model to perform condition-based monitoring at the subject operating at the target state.

15. The method of claim 1, further comprising:
sensing a change from the input state to the target state at the subject; and
responsive to the sensing the change, automatically collecting the frequency domain data for the target state for the subject.

16. The method of claim 1, further comprising:
storing the warping map at a map database, wherein the map database comprises a plurality of warping maps for different input states and target states.

17. A method for synthesizing frequency domain data for a target state, the method comprising:
receiving frequency domain data for a plurality of input states and a target state for a subject, wherein the frequency domain data exhibits morphologically dominant periodicity;
accessing warping maps for the plurality of input states to the target state that map between local regions of the frequency domain data for the plurality of input states and the target state;
generating a plurality of instances of synthetic frequency domain data at the target state based at least in part on applying the frequency domain data for the plurality of input states to the plurality of warping maps; and
blending the plurality of instances of the synthetic frequency domain data at the target state to generate blended synthetic frequency domain data.

18. The method of claim 17, further comprising:
applying a scaling factor to the plurality of instances of the synthetic frequency domain data at the target state to generate a plurality of instances of scaled synthetic frequency domain data at the target state, wherein the scaling factor is a ratio of amplitudes of the frequency domain data between the plurality of input states and the target state.

19. A non-transitory computer readable storage medium having computer readable program code stored thereon of a method for synthesizing frequency domain data for a target state, the method comprising:
receiving frequency domain data for an input state and a target state for a subject, wherein the frequency domain data exhibits morphologically dominant periodicity;
generating a warping map between local regions of the frequency domain data for the input state and the target state; and
generating synthetic frequency domain data at the target state based at least in part on applying the frequency domain data for the input state to the warping map.

20. The non-transitory computer readable storage medium of claim 19, the method further comprising:
applying a scaling factor to the synthetic frequency domain data, wherein the scaling factor is a ratio of amplitudes of the frequency domain data between the input state and the target state.
